(19) United States
(12) Patent Application Publication
(10) Pub. No.: US 2003/0175020 A1
(43) Pub. Date: Sep. 18, 2003

(54) Infrared radiator with a tubular envelope and a metallic reflective layer thereon, and a method for the manufacture thereof

(76) Inventors: Stefan Fuchs, Niedernberg (DE); Annette Lukas, Rodenbach (DE)

Correspondence Address: FULBRIGHT & JAWORSKI, LLP, 666 FIFTH AVE, NEW YORK, NY, 10103-3198, US

(21) Appl. No.: 10/376,487

(22) Filed: Feb. 28, 2003

(30) Foreign Application Priority Data
Mar. 13, 2002 (DE) 102 11 249.5-34

(51) Int. Cl. G02B 17/00; F21V 7/00

(52) U.S. Cl. 392/424

(57) ABSTRACT

In order to diminish radiation losses in infrared radiators having a heating conductor arranged in a tubular envelope of quartz glass or fused vitreous silica, a metallic reflective coating is applied to at least a portion of the surface of the tubular envelope, which is formed by firing onto quartz glass or fused vitreous silica, at a minimum temperature of +900EC, a bright noble metal preparation consisting of one or more noble metal compounds, at least one flux of organic metal compounds, and at least one organic vehicle serving as binding agent. The reflective coating that bears the noble metal can additionally be provided with an inorganic protective coating.

### BACKGROUND AND SUMMARY OF THE INVENTION

The invention relates to an infrared radiator with a heating conductor arranged in a tubular envelope of quartz glass or fused vitreous silica, and a metallic reflector coating applied to at least a portion of the surface of the tubular envelope, as well as to a method for forming the reflective coating.

An infrared radiator is disclosed in EP 0 465 759 B1, having a heating conductor arranged in a tubular envelope of quartz glass or fused vitreous silica where a metallic reflective coating is applied to the back of the tubular envelope in order to reduce radiation losses. The reflective coating consists of gold, palladium, platinum, a gold-palladium alloy or a gold-platinum alloy, and is provided with a protective coating of zirconium dioxide, silicon dioxide, tin dioxide or a mixture of at least two of these oxides.

Furthermore, EP 1 043 294 B1 has disclosed a bright noble metal preparation for turning onto ceramic/porcelain surfaces at a minimum temperature of 900EC, which consists of one or more organic noble metal compounds, at least one flux of organic metal compounds and at least one support, the bright noble metal preparation being rhodium-free, contains at least one organic gold-platinum-silver or palladium compound, contains Cr in the form of at least one organic compound, the chromium content being 0.01 to 1.0 mol Cr per mol of noble metal, and the noble metal content ranging from 2 to 20 weight-% with respect to the preparation.

Setting out from an infrared radiator as disclosed in EP 0 465 759 B1, the invention is addressed to the problem of creating a refractory metal reflective coating for infrared radiators which is sufficiently stable in a range up to 1200EC.

The problem is solved by the fact that the reflective coating consists of a bright metal preparation by burning it onto quartz glass or fused vitreous silica at a minimum temperature of +900EC, the bright metal preparation consisting of one or more organic noble metal compounds, at least one flux of organic metal compounds and at least one organic support which serves as binding agent.

High-temperature resistance in the reflective coating up to a heat of 1250EC proves especially advantageous.

Advantageous embodiments of the infrared radiator are disclosed herein.

In an advantageous embodiment, the reflective coating is formed from a bright metal preparation which is free of rhodium and contains at least one organic gold, platinum, silver or palladium compound, chromium being provided in the form of at least one organic compound and the Cr content is from 0.01 to 1.0 mol Cr per mol of noble metal, and the noble metal content with respect to the preparation ranges from 6 to 20 wt. %. The reflective coating thus formed has at least one noble metal of elements of the group, gold, platinum, palladium and silver; in practice a gold-bearing reflective coating has proven especially valuable for its stability.

In another preferred embodiment the reflective coating contains a gold alloy which contains at least one component of platinum, palladium or silver.

In a further advantageous embodiment the reflective coating has an alloy with components of gold, platinum and palladium. The Cr content of the reflective coating in this case preferably ranges from 0.05 to 0.4 mol Cr per mol of noble metal.

The total content of Si, Cr and Ni in the reflective coating amounts to 0.25 to 1.50 mol per mol of noble metal.

In one advantageous embodiment of the invention the bright metal preparation provided for the formation of the reflective coating contain at least one additional element from the group, Cu, Co, Sn, Zr, and Bi, in the form of organic compounds the content of Cu, Co, Sn, Zr and Bi amounting in each case to up to 0.3 mol per mol of noble metal.

The reflective coating then formed has additionally at least one element from the group, Cu, Co, Sn, Zr and Bi, the content of Cu, Co, Sn, Zr and Bi amounting to as much as 0.3 mol per mol of noble metal.

Furthermore, in an advantageous embodiment of the invention the formation of the reflective coating is accomplished, a bright noble metal preparation is used with at least one additional element from the group, B, Al, Ca, Ti, V, Mn, Fe, Zn, Ge, Pb, Sr, Mo, Ru, In, Ba, Ta, W, Os, Ir and Ce, in the form of organic compounds, the content of B, Al, Ca, Bi, V, Mn, Fe, Zn, Ge, Pb, Sr, Mo, Ru, In, Ba, Ta, W, Os, Ir and Ce amounting in each case to up to 0.3 mol per mol of noble metal. In that case the noble metal content with respect to the preparation amounts to 6 to 14 wt. %.

The reflective coating then formed additionally has at least one additional element from the group, B, Al, Ca, Bi, V, Mn, Fe, Zn, Ge, Pb, Sr, Mo, Ru, In, Ba, Ta, W, Os, Ir and Ce, the content of B, Al, Ca, Bi, V, Mn, Fe, Zn, Ge, Pb, Sr, Mo, Ru, In, Ba, Ta, W, Os, Ir and Ce amounting in each case to up to 0.3 mol per mol of noble metal.

The reflective coating is thorium-free, the thickness of the reflective coating ranging from 0.05 μm to 5 μm. In an advantageous embodiment the reflective coating is applied to a tubular envelope in the form of a hollow cylinder.

In a further advantageous embodiment the reflective coating is applied to a tubular envelope that is part of a twin tube.

Advantageously the reflective coating is applied to a circular cylindrical tubular envelope as a partial peripheral jacket with an aperture angle ranging from 50E to 300E.

The reflective coating can additionally be provided with inorganic protective coatings. These are usually of silicatic construction and contain, for example, zirconium oxide, silicon dioxide or tin oxide or mixtures of these oxides.

In a procedure for the application of a reflective coating to a tubular envelope of quartz glass or vitreous fused silica for an infrared radiator provided with a heating conductor, the above-described bright noble metal preparation, as referred to in claims 1, 2 and 7, is applied to at least one surface or one portion of the surface of the tube and then fired in a temperature range of 900EC to 1300EC, preferably in the temperature range of 900EC to 1200EC. The bright metal preparation is applied to the surface of the tubular envelope by spraying, spreading (e.g., with a brush) or by other methods of application, e.g., by means of a transfer.

For the coating operation, either a portion of the surface on the back of the tubular envelope is provided, or a portion of the inside surface of the tubular envelope.

The subject of the invention is further explained with the aid of FIGS. 1 and 2.

### BRIEF DESCRIPTION OF THE FIGURES

FIG. 1 shows schematically an infrared radiator having two coil filaments arranged parallel to one another in a housing of quartz glass; the total length is not shown (there is an interruption around the middle part) for better comprehension.

FIG. 2 shows a cross section taken along the line AA through the infrared radiator of FIG. 1.

### DETAILED DESCRIPTION

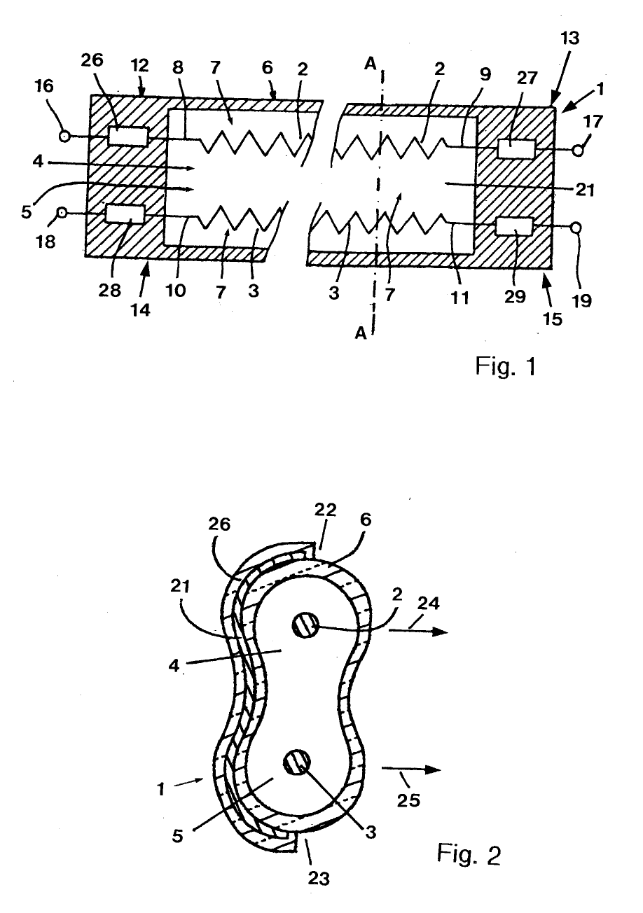

In FIG. 1, the infrared radiator 1 designed as a dual-tube radiator has two parallel coiled incandescent filaments 2 and 3 which are situated one in each of the parallel tubular envelope segments 4 and 5 which form a single quartz glass tubular envelope 6 with a common interior 7. The coiled filaments 2 and 3 are connected together electrically and mechanically at their extremities 8 and 9 as well as 10 and 11 by means of flat lead-throughs 26, 27, 28 and 29 made of molybdenum in the pinch areas of the tube ends 12, 13, 14, 15, each having an external terminal 16, 17, 18 and 19; the power supply to the filaments 2 and 3 is delivered through the terminals. On the exterior back of the quartz glass envelope 6 opposite the interior 7 a metallic reflective coating is applied, by which the infrared radiation produced by the filaments 2 and 3 is focused in a given direction, as will be further explained with the aid of FIG. 2.

According to FIG. 2, the quartz glass envelope 6 encompassing the filaments 2 and 3, represented schematically in cross section, has a reflective coating 21 of a bright noble metal on the back of this envelope—i.e., in a direction contrary to that of the emission of radiation—which extends as far as the lower and upper apexes 22 and 23, respectively, of the envelope sections 4 and 5; this kind of coating is approximately equal to an exit angle in the range from 170 to 180E in the case of cylindrical tubular envelopes. By means of the reflective coating 21, the radiation formed by the filaments 2 and 3 is so focused that it emerges from the filaments along their respective axes 24 and 25. The radiation axes 24 and 25 are associated respectively with the filaments 2 and 3, -represented each in cross section.

Since the applied reflective coating 21 consists of a layer of a very thinly applied noble metal, it can additionally be protected by a protective coating 26 of inorganic material applied to the back of the reflective coating 21; preferably this material consists of an oxide material, such as for example zirconium dioxide, silicon dioxide or tin oxide, or also a mixture of different oxides.

The following example will serve to explain the invention.

### EXAMPLE

| A bright gold preparation, consisting of | |
|---|---|
| Gold sulforesinate (54% Au) | 18.5 weight-% |
| Chromium resinate (10% Cr) | 5.0 weight-% |
| Silicon resinate dissolved in pine oil (10% Si) | 5.0 weight-% |
| Nickel resinate (10% Ni) | 5.0 weight-% |
| Sulfurated terpentine oil | 30.0 weight-% |
| Xylene | 15.0 weight-% |
| Pine oil | 21.5 weight-% |

is applied with a brush to a quartz tubular envelope and then fired at a temperature in the range from 900EC to 1300EC and at a temperature rise rate of 20 K/min. A yellow-gold, very bright gold film very resistant to abrasion forms on the tubular envelope; the yellow-gold, very bright gold film has very good adhesive strength and high-temperature stability for heating up to 1250EC.

What is claimed is:

1. Infrared radiator with a heating conductor arranged in a tubular envelope of quartz glass or fused silica glass and a metallic reflective layer applied to at least a portion of the surface of the tubular envelope, characterized in that the reflective layer (21) is formed from a bright noble metal preparation by burning it onto quartz glass, or fused silica at a minimum temperature of +900EC, consisting of one or more organic noble metal compounds, at least one flux made of organic metal compounds, and at least one organic support serving as binding agent.

2. Infrared radiator according to claim 1, characterized in that the reflective layer (21) is formed by a bright noble metal preparation, which is
rhodium-free,
contains at least one organic gold, platinum, silver or palladium compound,
has Cr in the form of at least one organic compound, the Cr content amounting to 0.01 to 1.0 mol Cr per mol of noble metal,
has at least one additional element from the group Ni and Si in the form of organic compounds, the total content of Cr, Ni and Si amounting to 0.2 to 3 mol per mol of noble metal in the reflective layer, and
the noble metal content, with respect to the preparation, is in the range of 6 to 20 weight-percent.

3. Infrared radiator according to claim 2, characterized in that the Cr Content of the reflective layer (21) amounts to 0.05 to 0.4 mol Cr per mol of noble metal.

4. Infrared radiator according to claim 3, characterized in that the total content of Si, Cr and Ni in the reflective layer (21) amounts to 0.25 to 1.50 mol per mol of noble metal.

5. Infrared radiator according to any of claims 1 to 4, characterized in that the reflective layer (21) has at least one additional element from the group, Cu, Co, Sn, Zr and Bi, the content of the Cu, Co, Sn, Zr and Bi amounting in each case to 0.3 mol per mol of noble metal.

6. Infrared radiator according to any of claims 1 to 5, characterized in that the reflective layer (21) has at least one additional element from the group, B, Al, Ca, Ti, V, Mn, Fe, Zn, Ge, Pb, Sr, Mo, Ru, In, Ba, Ta, W, Os, Ir and Ce, the content of B, Al, Ca, Ti, V, Mn, Fe, Zn, Ge, Pb, Sr, Mo, Ru, In, Ba, Ta, W, Os, Ir and Ce amounting in each case to up to 0.3 mol per mol of noble metal.

7. Infrared radiator according to any of claims 1 to 6, characterized in that the noble metal content of the bright metal preparation provided for the formation of the reflective layer (21) amounts to 6 to 14 weight-% with respect to the preparation.

8. Infrared radiator according to any of claims 1 to 7, characterized in that the reflective layer (21) is thorium-free.

9. Infrared radiator according to any of claims 1 to 8, characterized in that the thickness of the reflective layer (21) ranges from 0.05 μm to 5 μm.

10. Infrared radiator according to any of claims 1 to 9, characterized in that the reflective layer (21) is applied to a tubular envelope in the form of a hollow cylinder.

11. Infrared radiator according to any of claims 1 to 10, characterized in that the reflective layer (21) is applied to a tubular envelope (6) configured as part of a twin tube.

12. Infrared radiator according to any of claims 1 to 11, characterized in that the reflective layer is applied to a cylindrical tubular envelope as a jacketing segment with an aperture angle in the range from 50E to 300E.

13. Infrared radiator according to any of claims 1 to 12, characterized in that the reflective layer (21) is provided with at least one inorganic protective covering.

14. Infrared radiator according to claim 13, characterized in that the reflective layer (21) is provided with a protective coating of zirconium dioxide, silicon dioxide, tin oxide or a mixture of at least two of these oxides.

15. Method for the formation of a reflective layer on a tubular envelope of quartz glass or vitreous fused silica for an infrared radiator provided with a heating conductor, characterized in that a bright metal preparation according to any of claims 1, 2 and 7 is applied to at least one surface of the tubular envelope and thereafter is burned on in a temperature range from 900EC to 1300EC, preferably in the temperature range from 900EC to 1200EC.

16. Method according to claim 15, characterized in that the bright metal preparation is applied by spraying onto the surface of the tubular envelope.

17. Method according to claim 15, characterized in that the bright metal preparation is applied by means of a transfer to the surface of the tubular envelope.

18. Method according to claim 15, characterized in that the bright metal preparation is applied by spreading.

19. Method according to any of claims 5 to 18, characterized in that the bright metal preparation for forming the reflective coating is applied to the rear side of the tubular envelope.

20. Method according to any of claims 15 to 19, characterized in that the bright metal preparation for the formation of the reflective coating is applied to the inside of the tubular envelope

21. An infrared radiator comprising a heating conductor arranged in a tubular envelope of quartz glass or fused silica glass and a metallic reflective layer applied to at least a portion of the surface of the tubular envelope, wherein the reflective layer is formed from a bright noble metal preparation by burning said bright nobel metal preparation onto quartz glass or fused silica glass at a minimum temperature of +900EC, said bright noble metal preparation comprising at least one organic noble metal, at least one flux comprising an organic metal compound, and at least one organic support as a binding agent.

22. An infrared radiator according to claim 21, wherein the reflective layer is rhodium-free; comprises at least one organic gold, platinum, silver or palladium compound; and also comprises Cr in the form of at least one organic compound, the Cr content amounting to 0.01 to 1.0 mol Cr per mol of noble metal, and further comprises at least one additional element from the group Ni and Si in the form of an organic compounds, the total content of Cr, Ni and Si amounting to 0.2 to 3 mol per mol of noble metal in the reflective layer, and wherein the noble metal content, with respect to the preparation, is in the range of 6 to 20 weight-percent.

23. An infrared radiator according to claim 22, wherein the Cr content of the reflective layer amounts to 0.05 to 0.4 mol Cr per mol of noble metal.

24. An infrared radiator according to claim 23, wherein the total content of Si, Cr and Ni in the reflective layer amounts to 0.25 to 1.50 mol per mol of noble metal.

25. An infrared radiator according to claim 21, wherein said reflective layer has at least one additional element from the group, Cu, Co, Sn, Zr and Bi, the content of the Cu, Co, Sn, Zr and Bi amounting in each case to 0.3 mol per mol of noble metal.

26. An infrared radiator according to claim 21, wherein said reflective layer further comprises at least one additional element from the group, B, Al, Ca, Ti, V, Mn, Fe, Zn, Ge, Pb, Sr, Mo, Ru, In, Ba, Ta, W, Os, Ir and Ce, the content of B, Al, Ca, Ti, V, Mn, Fe, Zn, Ge, Pb, Sr, Mo, Ru, In, Ba, Ta, W, Os, Ir and Ce amounting for each additional element up to 0.3 mol per mol of noble metal.

27. An infrared radiator according to claim 21, wherein the noble metal content of the bright metal preparation provided for the formation of the reflective layer amounts to 6 to 14 weight-% with respect to the preparation.

28. An infrared radiator according to claim 21, wherein the reflective layer is thorium-free.

29. An infrared radiator according to claim 21, wherein the thickness of the reflective layer ranges from 0.05 μm to 5 μm.

30. An infrared radiator according to claim 21, wherein the reflective layer is applied to a tubular envelope in the form of a hollow cylinder.

31. An infrared radiator according to claim 21, wherein the reflective layer is applied to a tubular envelope configured as part of a twin tube.

32. An infrared radiator according to claim 21 wherein the reflective layer is applied to a cylindrical tubular envelope as a jacketing segment with an aperture angle in the range from 50E to 300E.

33. An infrared radiator according to claim 21, wherein the reflective layer is provided with at least one inorganic protective covering.

34. An infrared radiator according to claim 33, wherein the reflective layer is provided with a protective coating of zirconium dioxide, silicon dioxide, tin oxide or a mixture of at least two of these oxides.

35. A method for the formation of a reflective layer on a tubular envelope of quartz glass or vitreous fused silica for an infrared radiator provided with a heating conductor, wherein said bright metal preparation according to claim 21 is applied to at least one surface of a tubular envelope and thereafter is burned on in a temperature range from 900EC to 1300EC.

36. A method according to claim 35, wherein the bright metal preparation is applied by spraying onto the surface of the tubular envelope.

37. A method according to claim 35, wherein the bright metal preparation is applied by means of a transfer to the surface of the tubular envelope.

38. A method according to claim 35, wherein the bright metal preparation is applied by spreading.

39. A method according to claim 25, wherein the bright metal preparation for forming the reflective coating is applied to the rear side of the tubular envelope.

40. A method according to claim 35 wherein the bright metal preparation for the formation of the reflective coating is applied to the inside of the tubular envelope.

41. The method of claim 35, wherein the temperature ranges from 900° C. to 1200° C.
